(19) United States
(12) Patent Application Publication
(10) Pub. No.: US 2024/0116792 A1
(43) Pub. Date: Apr. 11, 2024

(54) METHOD FOR THE COMBINED RECYCLING OF PHOSPHATE AND NITROGEN FROM SEWAGE SLUDGE AND OPTIONALLY BIOLOGICAL WASTE

(71) Applicant: Remondis Aqua GmbH & Co. KG, Lünen (DE)

(72) Inventor: Martin Lebek, Burgdorf (DE)

(73) Assignee: Remondis Aqua GmbH & Co. KG, Lünen (DE)

(21) Appl. No.: 18/546,326

(22) PCT Filed: Feb. 15, 2022
(86) PCT No.: PCT/DE2022/100126

§ 371 Date: Aug. 14, 2023

(30) Foreign Application Priority Data
Feb. 15, 2022 (DE) 10-2021-103-522.8
Feb. 16, 2022 (DE) 10-2021-000-786.7

(51) Int. Cl. C02F 11/06; C02F 1/42; C02F 11/00; C02F 11/12

(52) U.S. Cl. CPC C02F 11/06; C02F 1/42; C02F 11/008; C02F 11/12; C02F 2101/105

(57) ABSTRACT

The invention relates to a process for the combined recycling of phosphate and nitrogen from sewage sludge. The core task of the invention consists of the recycling of phosphorous from sewage sludge ash and the reaction of phosphorous with nitrogen from the vapors of the sewage sludge drying and the manure to form NP fertilizer diammonium phosphate.

### SUBJECT OF THE INVENTION

The invention relates to a process for the combined recycling of phosphate and nitrogen from sewage sludge and optionally biological wastes such as manure, comprising an aqueous liquid phase. The core task of the invention consists of the recycling of phosphorous from sewage sludge ash and the reaction of phosphorous with nitrogen from the vapors of the sewage sludge drying and the manure to form NP fertilizer diammonium phosphate.

### BACKGROUND OF THE INVENTION

Phosphorus in all its compounds is essential for life. People, animals and plants depend on its availability. However, phosphate is mainly extracted from phosphate-bearing rocks in geogenic deposits (Morocco, China, USA). Germany is 100% dependent on imports. The problem that arises from this is that these deposits are finite and the heavy metal pollution from cadmium and uranium increases with increasing mining depth. For resource and environmental protection reasons, the recycling of phosphorus is an indispensable step.

Since sewage sludge as a resource offers the greatest phosphorus recycling potential, new political and legal framework conditions were created at federal level by amending the Waste Sewage Sludge Ordinance (AbfKlärV). In the future, the recovery of phosphorus in the course of sewage sludge disposal in Germany will be of central importance and will be required by law.

Processes for the recovery of phosphorus from sewage sludge ash are shown by the patents DE 10 2013 018 650 B3, DE 10 2013 018 652 A1 and DE 10 2014 006 278 B3 of the applicant.

The amendment of the Sewage Sludge Ordinance (AbfKlärV) of Oct. 3, 2017 aims in particular to return the valuable components of the sewage sludge (phosphorus) more comprehensively than before to the economic cycle and at the same time to significantly restrict the conventional soil-related sewage sludge utilization for the purpose of further reducing the pollutant input into the soil. According to the AbfKlärV, all sewage treatment plant operators are obliged to recycle phosphorus. Agricultural recycling will only be possible to a limited extent in the future.

It would therefore be desirable to dispose of sewage sludge or sewage sludge ash in an economical manner and at the same time to recover the combined valuable phosphate and nitrogen contained therein.

### OBJECT OF THE INVENTION

The object of the present invention was therefore to provide processes for the combined recovery of phosphate and nitrogen from sewage sludge or sewage sludge ash.

### OVERVIEW OF THE INVENTION

As stated above, the core task of the invention is the recovery of phosphorus from sewage sludge ash and the conversion of phosphorus with nitrogen from the vapors of sewage sludge drying and from manure to the NP fertilizer diammonium phosphate. The invention offers the enormous advantage that processes are offered here for the first time in which phosphate and nitrogen are combined and recovered from sewage sludge or sewage sludge ash in an integrated process.

The recovery of phosphorus from sewage sludge is a central process component of the invention, as is the recovery of nitrogen from manure, with NH₃ being obtained by stripping. This is converted together with the NH₃-containing vapors from the sewage sludge post-drying with the phosphoric acid obtained to form diammonium phosphate. The patent right DE DE10 2016 122 869 B4 of the applicant shows processes for the treatment of manure.

The generation of sewage sludge ash is an integral part of phosphorus recycling based on material and energetic intersections and synergies. Phosphorus is then extracted from this ash in the form of phosphoric acid. It is the central basic chemical of the phosphorus industry. In addition to phosphoric acid, other secondary raw materials such as gypsum and metal salts (iron, aluminum) are recovered. The recyclables are used in the building materials industry (gypsum) and as precipitants in sewage treatment plants (metal salts). The ash left over at the end of the process is used as an aggregate in the building materials industry.

During the post-drying of the sewage sludge to approx. 40% DM (dry matter) required for incineration, NH₃-rich vapors are formed, which are condensed and directly reacted with phosphoric acid in a phosphoric acid trickling system. The resulting diammonium phosphate is used locally as an aqueous, approx. 10% solution directly as a fertilizer or is crystallized out by evaporation and cooling and dried and granulated to form a common NP fertilizer.

The manure is utilized in an integrated overall process. The manure is treated with CO₂ under pressure in a pressure tank, during which the phosphate contained in the solid particulate phase is converted into the liquid phase. After expansion, the solids are separated by centrifugation. The phosphorus and nitrogen contained in the manure is now concentrated in the liquid phase. By alkalizing with milk of lime (Ca(OH)₂) and possibly introducing steam, NH₃ is stripped out and phosphorus is precipitated as tricalcium phosphate (apatite). The NH₃ is also converted to diammonium phosphate in the (e.g. trickling system) plant together with the NH₃-rich vapors from the subsequent drying of the sewage sludge, as described above. The precipitated tricalcium phosphate is thermally treated together with dried sewage sludge in the planned sewage sludge incineration plant and then fed into the phosphorus recovery process. At the end of the treatment process, a residue liquid remains of the manure, which only contains traces of phosphorus and nitrogen, but is rich in potassium and can be used for irrigation or treated using a purification process so that it can be returned to the water cycle. The dewatered solid phase can be further used in a biogas plant or used directly for soil improvement.

### DETAILED DESCRIPTION OF THE INVENTION

According to the invention, this object is achieved by processes for the combined recovery of phosphate and nitrogen from (and with treatment of) sewage sludge and optionally biological waste such as manure, which comprises an aqueous liquid phase. In process (1), the combined recovery of phosphate and nitrogen occurs only from sewage sludge. In the combination process (2), the combined recovery of phosphate and nitrogen from sewage sludge is combined with the processing of biological waste, which includes an aqueous liquid phase, these being in particular manure, liquid manure and fermentation residues from biogas plants.

In one aspect (1) of the invention, the invention relates to a process (1) for the combined recovery of phosphate and nitrogen from sewage sludge, comprising the following process stages:
Stage (1A1): Optional disintegration of the sewage sludge;
Stage (1A2): Drying of the sewage sludge, resulting in vapors rich in NH₃ and dried sewage sludge;
Stage (1B1): Optional condensing of the NH₃-rich vapors from Stage (1A2);
Stage (1B2): Optional alkalizing of the condensed NH₃-rich vapors from stage (1B1) with release of ammonia [NH₃], (preferably using CaO or Ca(OH)₂ (lime milk), if necessary in a mixture with NaOH) and driving out of the ammonia [NH₃] with heating and/or by applying a reduced pressure and/or with the aid of an air or steam flow (ammonia stripping 1);
Stage (1D2): Incinerating the dried sewage sludge from stage (1A2) into sewage sludge ash;
Stage (1D3): Treating the sewage sludge ash from stage (1D2) with phosphoric acid;
Stage (1D4): Separating the acid-insoluble portion of the treated sewage sludge ash from stage (1D3) to produce an acid-insoluble portion and a filtrate or supernatant in the form of a phosphoric acid-containing liquid;
Stage (1D5): Optional recycling of at least a part of the phosphoric acid-containing liquid from stage (1D4) for use in stage (1D3);
Stage (1D6): Purifying the phosphoric acid-containing liquid from stage (1D4) by adding sulfuric acid to the phosphoric acid-containing liquid from stage (1D4) so that a calcium sulfate precipitate is recovered and separated, and/or by applying ion exchange or Liquid-liquid extraction, resulting in a purified phosphoric acid-containing liquid;
Stage (1D7): Optional concentrating of at least a part of the purified phosphoric acid-containing liquid from stage (1D6) so that phosphoric acid is recovered and separated; and
Stage (1 E): Reacting the condensed NH₃-rich vapors from stage (1B1) and/or the ammonia [NH₃] obtained in stage (1B2) with phosphoric acid [H₃PO₄] in the form of the phosphoric acid-containing liquid from stage (1D4), the purified phosphoric acid-containing liquid from stage (1D6) and/or the phosphoric acid from stage (1D7) to obtain ammonium phosphate compound, preferably di-ammonium hydrogen phosphate [(NH₄)₂HPO₄] (Fertilizer), and optional separating off of the ammonium phosphate compound obtained.

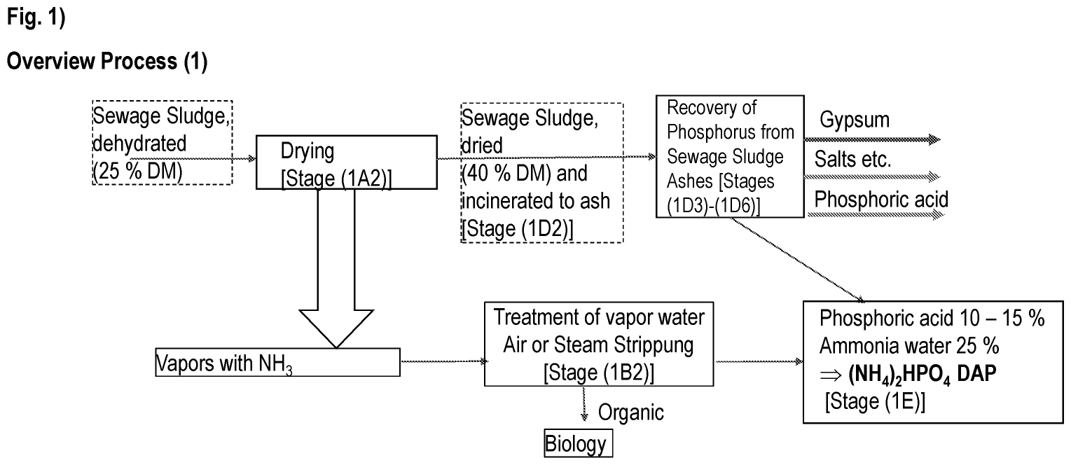

FIG. 1 (FIG. 1) outlines and illustrates important stages of the process (1), as described above, in an overview.

In another aspect (2) of the invention, the invention relates to a Combination process (2) for the combined recovery of phosphate and nitrogen from sewage sludge and biological waste, the biological waste comprising an aqueous liquid phase in which at least urea and ammonium compounds and inorganically and organically bound phosphates are dissolved and/or contained in particulate form, comprising the following process stages:
Stage (2A1): Optional disintegration of the sewage sludge;
Stage (2A2): Drying of the sewage sludge, resulting in vapors rich in NH₃ and dried sewage sludge;
Stage (2B1): Optional condensing of the NH₃-rich vapors from Stage (2A2);
Stage (2B2): Optional alkalizing of the condensed NH₃-rich vapors from stage (2B1) with release of ammonia [NH₃], and driving out the ammonia [NH₃] with heating and/or by applying a reduced pressure and/or with the aid of an air or steam flow (ammonia stripping 2);
Stage (2C1): Optionally separating the solids of the biological waste from the liquid phase;
Stage (2C1): Introducing carbon dioxide gas [CO₂] under increased pressure or supercritical carbon dioxide into the liquid phase of the biological waste in order to solubilize particulate-bound phosphates;
Stage (2C2): Reducing the CO₂ content in the liquid phase from stage (2C1) by acidifying the liquid phase and driving off dissolved CO₂ and/or CO₂ bound as carbonate;
Stage (2C4): Alkalizing the liquid phase from stage (2C3) or (2C3) with release of ammonia [NH₃] and driving out the ammonia [NH₃] with heating and/or by applying a reduced pressure and/or with the aid of an air or steam stream (ammonia stripping 3);
Stage (2C5): Precipitation and separation of calcium phosphate from the liquid phase from stage (2C4);
Stage (2D1): Admixing the precipitated and separated calcium phosphate from stage (2C5) to the dried sewage sludge from stage (2A);
Stage (2D2): Incinerating the mixture of precipitated and separated calcium phosphate from stage (2C4) and dried sewage sludge from stage (2A) to sewage sludge ash;
Stage (2D3): Treating the sewage sludge ash from stage (2D2) with phosphoric acid;
Stage (2D4): Separating the acid-insoluble portion of the treated sewage sludge ash from stage (2D3) to produce an acid-insoluble portion and a filtrate or supernatant in the form of a phosphoric acid-containing liquid;
Stage (2D5): Optional recycling of at least a part of the phosphoric acid-containing liquid from stage (2D4) for use in stage (2D3);
Stage (2D6): Purifying the phosphoric acid-containing liquid from stage (2D4) by adding sulfuric acid to the phosphoric acid-containing liquid from stage (2D4) so that a calcium sulfate precipitate is recovered and separated, and/or by applying ion exchange or Liquid-liquid extraction, resulting in a purified phosphoric acid-containing liquid;
Stage (2D7): Optional concentrating of at least a part of the purified phosphoric acid-containing liquid from stage (2D6) so that phosphoric acid is recovered and separated;
Stage (2E): Reacting the condensed NH₃-rich vapors from stage (2B1) and/or the ammonia [NH₃] obtained in stage (2B2) and the ammonia [NH₃] obtained in stage (2C4) with phosphoric acid [H₃PO₄] in the form of the phosphoric acid-containing liquid from stage (2D4), the purified phosphoric acid-containing liquid from stage (2D6) and/or the phosphoric acid from stage (2D7) to obtain ammonium phosphate compound, and optionally separating the ammonium phosphate compound obtained.

Preferred embodiments of aspect (1) and/or aspect (2) are detailed below, it being noted that these can each be combined with one another and, for example, particularly preferred embodiments of a stage with at least one other preferred embodiment of a stage or multiple stages can be combined.

In preferred embodiments of aspect (1) of the invention, the process (1) for the combined recovery of phosphate and nitrogen from sewage sludge, the sewage sludge ash in stage (1D2) is exclusively ash obtained by incineration of the originally used sewage sludge from stages (1A1) and (1A2). These are phosphate-containing sewage sludges. In an embodiment of aspect (1) of the invention, the process (1) for the combined recovery of phosphate and nitrogen from sewage sludge, the sewage sludge ash in stage (1D2) may also have other phosphate-containing ash associated therewith, for example any ash produced by incineration of phosphate-containing sewage sludge, biodegradable waste, biowaste and/or animal waste is obtained in a waste incinerator. The sewage sludge ash resulting from the incineration of the sewage sludge (used in stages (1A1) and (1A2)) in stage (1D2) has a phosphate content (measured in P₂O₅) of ≥3% by weight, of ≥5% by weight, of ≥7% by weight, of ≥10% by weight, of ≥15% by weight or of ≥20% by weight (whereby a phosphate content (measured in P₂O₅) of ≥40% by weight or ≥35% by weight is rare), or a phosphorus content (P) of ≥1% by weight, of ≥2% by weight, of ≥3% by weight, of ≥5% by weight, of ≥8% by weight or of ≥10% by weight (whereby a phosphate content (measured in P) of >15% by weight or >14% by weight is rare).

In preferred embodiments of aspect (2) of the invention, the combination process (2) for the combined recovery of phosphate and nitrogen both from sewage sludge and from biological waste, the biological waste is preferably manure, liquid manure and/or fermentation residues from biogas plants. In preferred embodiments of aspect (2) of the invention, the combination process (2) for the combined recovery of phosphate and nitrogen from both sewage sludge and biological waste, the sewage sludge ash in stage (2D2) is exclusively ash produced by incineration of the originally used sewage sludge from stages (2A1) and (2A2). These are phosphate-containing sewage sludges. In one embodiment, other phosphate-containing ash can also be added to the sludge ash in stage (2D2), for example any ash obtained by incineration of phosphate-containing sewage sludge, biodegradable waste, biowaste and/or animal waste in a waste incinerator. In principle, the sewage sludge ash can then also contain other (phosphate-containing) ash, for example ash obtained by incinerating phosphate-containing sewage sludge, biodegradable waste, biowaste and/or animal waste in a waste incineration plant. The sewage sludge ash resulting from the incineration of the sewage sludge (used in stages (2A1) and (2A2)) in stage (2D2) has a phosphate content (measured in P₂O₅) of ≥3% by weight, of ≥5% by weight, of ≥7% by weight, of ≥10% by weight, of ≥15% by weight or of ≥20% by weight (whereby a phosphate content (measured in P₂O₅) of ≥40% by weight or of >35% by weight is rare), or a phosphorus content (P) of >1% by weight, of ≥2% by weight, of ≥3% by weight, of ≥5% by weight, of ≥8% by weight or of ≥10% by weight (whereby a phosphate content (measured in P) of ≥1% by weight or of ≥14% by weight is rare). In preferred embodiments of aspect (2) of the invention, the combination process (2), urea contained in the biological waste with an aqueous liquid phase in the liquid phase is hydrolyzed by adding the enzyme urease to obtain ammonia and/or ammonium.

In preferred embodiments stage (1A1) or (2A1), the disintegration of the sewage sludge, is carried out before stage (1A2) or (2A2), whereby stage (1A1) or (2A1) is preferably carried out by mechanical treatment (for example using a ball mill, by treatment using ultrasound and/or at elevated pressure and temperature.) This disintegration increases the ammonia yield in the vapors formed as a result of the drying in stage (1A2) or (2A2).

In preferred embodiments of stage (1A2) or (2A2), the sewage sludge is dried at elevated temperatures and/or the NH₃-rich vapors produced by the drying are collected directly at the drying site. Usually (mechanically) dewatered sewage sludge has, in particular, about 25% DM (dry matter, % by weight). For incineration it is necessary to dry the sewage sludge to approx. 40% DM (dry matter, % by weight). This takes place in this stage, whereby e.g. belt dryers or fluidized bed dryers can be used and whereby e.g. temperatures of 40° C. to 95° C. or 50° C. to 80° C., or 60° C. to 70° C. can be used.

In preferred embodiments of stage (1B1) or (2B1), the condensation of the NH₃-rich vapors from stage (1A2) or (2A2) is carried out, preferably directly at the drying site. The stage can be omitted if the vapors are already liquid.

In preferred embodiments of the optional stage (1B2) or (2B2), the alkalizing of the condensed NH₃-rich vapors from stage (1B1) or (2B1) is not optionally carried out, but instead follows stage (1B1) or (2B1). In preferred embodiments of the optional stage (1B2) or (2B2) the alkalizing of the condensed NH₃-rich vapors from stage (1B1) or (2B1), is carried out by means of addition of NaOH, optionally with further addition of CaO or Ca(OH)₂ (milk of lime), especially optionally with further addition of Ca(OH)₂ (milk of lime). In preferred embodiments of stage (1B2) or (2B2), the driving out of the ammonia [NH₃] (ammonia stripping 1 or 2) is carried out with heating. In preferred embodiments of stage (1B2) or (2B2), the ammonia [NH₃] is driven out (ammonia stripping 1 or 2) by applying a reduced pressure. In preferred embodiments of stage (1B2) or (2B2), the ammonia [NH₃] is driven out (ammonia stripping 1 or 2) with the aid of an air or steam stream. In preferred embodiments of stage (1B2) or (2B2), the ammonia [NH₃] is driven out (ammonia stripping 1 or 2) with heating and with the aid of an air or steam stream. The release and driving out of the ammonia in the liquid phase in stage (1B2) or (2B2) of the process according to the invention, known as ammonia stripping, is known in principle. It is carried out according to the invention by making the liquid phase alkaline, for example using CaO or Ca(OH)₂ (lime milk), optionally in a mixture with NaOH, and driving out the gaseous ammonia with heating and/or by applying a reduced pressure and/or with the aid of an air or steam flow. The liquid phase can be alkalized up to a pH of 9 to 14, preferably 10 to 13, particularly preferably 11 to 12. The gaseous ammonia driven out can be absorbed in mineral acid or water (ammonia water).

In preferred embodiments, in stage (2C1) the solids (if present; for example plant remains or straw etc.) of the biological waste can be separated from the liquid phase by mechanical separation. This can be done, for example, by sieving, using a rake, by sedimentation, filtration, centrifugation or a combination of these processes. Alternatively or additionally, the starting material can also be made to flow by mechanically crushing the coarse solids, for example by chopping, grinding or a comparable suitable process. The separation is preferably carried out by centrifugation. In one embodiment, the stage (1C1) or (2C1), separating the solids of the biological waste from the liquid phase, is carried out after stage (2C2).

In preferred embodiments of the stage (2C2), the introduction of carbon dioxide gas [CO₂] under increased pressure or of supercritical carbon dioxide into the liquid phase of the biological wastes is carried out in a pressure vessel. The aim is to bring particle-bound phosphates into solution. A process for obtaining phosphates from sewage sludge products by introducing carbon dioxide gas (CO₂) under increased pressure or supercritical carbon dioxide into the liquid phase is known from DE 102009020745, which is incorporated herein by reference. The process described therein can be used accordingly in stage (2C2) of the process according to the invention in order to solubilize particulate-bound phosphates according to the invention.

In preferred embodiments of stage (2C3), the reduction of the CO₂ content in the liquid phase from stage (2C2) is carried out by acidifying the liquid phase using inorganic acids. This enables dissolved CO₂ and/or CO₂ bound as carbonate to be driven out from the liquid phase. Increasing the pH value by making it alkaline with NH₃ and/or CaO or Ca(OH)₂ in the stage (2C4) for the ammonia stripping (3), would due to the high CO₂ content in the liquid phase not only the desired calcium phosphate be formed, but also a large proportion of undesired calcium carbonate. Thus, before the liquid phase is alkalized for the ammonia stripping in the subsequent stage (2C4), the CO₂ content in the liquid phase is reduced according to the invention by acidifying the liquid phase and driving off dissolved CO₂ and/or CO₂ bound as carbonate. The acidification is preferably carried out with phosphoric acid. Driving out the CO₂ can advantageously be accelerated by increasing the temperature and/or by stirring or otherwise moving the reaction mixture.

In preferred embodiments of stage (2C4), the alkalizing of the liquid phase from stage (2C3) is done by adding NaOH, optionally with further addition of CaO or Ca(OH)₂ (milk of lime), in particular optionally with further addition of Ca(OH)₂ (milk of lime). In preferred embodiments of stage (2C4), the ammonia [NH₃] is driven out (ammonia stripping 3) with heating. In preferred embodiments of stage (2C4), the ammonia [NH₃] is driven out (ammonia stripping 3) by applying a reduced pressure. In preferred embodiments of stage (2C4), the ammonia [NH₃] is driven out (ammonia stripping 3) with the aid of an air or steam stream. In preferred embodiments of stage (2C4), the ammonia [NH₃] is driven out (ammonia stripping) with heating and with the aid of an air or steam stream (ammonia stripping 3). The release and driving out of the ammonia in the liquid phase in Stage (2C4) of the process according to the invention, the so-called ammonia stripping, is known in principle. It is carried out according to the invention by alkalizing the liquid phase, for example using CaO or Ca(OH)₂ (lime milk), optionally in a mixture with NaOH, and driving out the gaseous ammonia with heating and/or by applying a reduced pressure and/or with the aid of an air or steam stream. The liquid phase can be alkalized up to a pH of 9 to 14, preferably 10 to 13, particularly preferably 11 to 12. The gaseous ammonia driven out can be absorbed in mineral acid or water (ammonia water).

In preferred embodiments of stage (2C5), the precipitation and separation of calcium phosphate from the liquid phase from stage (2C4), the calcium phosphate is preferably in the form of tricalcium phosphate [Ca₃(PO₄)₂] or hydroxyapatite [Ca₅(PO₄)₃(OH)]. Here, however, calcium phosphate includes Ca₃(PO₄)₂), CaHPO₄, Ca₅(PO₄)₃(OH) and Ca(H₂PO₄)₂. In preferred embodiments of stage (2C5), the separation of calcium phosphate from the liquid phase is carried out by means of filtration, centrifugation, sedimentation or a combination of the aforementioned methods.

In preferred embodiments of stage (2D1), the precipitated and separated calcium phosphate from stage (2C5) is admixed to the dried sewage sludge from stage (2A), it being possible to use various mixing methods. The aim of this admixture is to eliminate the organic residues usually accompanying the calcium phosphate from stage (2C5) by the subsequent incineration in stage (2D2).

In preferred embodiments of stage (2D2), the mixture of precipitated and separated calcium phosphate from stage (2C4) and dried sewage sludge from stage (2A2) is incinerated to form sewage sludge ash, with the organic residues attached to the calcium phosphate from stage (2C4) also being removed being incinerated. In preferred embodiments of stage (2D2), the mixture of precipitated and separated calcium phosphate from stage (2C4) and dried sewage sludge from stage (2A2) is incinerated to form sewage sludge ash in a waste incineration plant at 600° to 1,200° C., preferably at 800° to 900° C.

In preferred embodiments of stage (1D2), the dried sewage sludge from stage (1A2) is incinerated to form sewage sludge ash, the organic residues in particular being incinerated. In preferred embodiments of stage (1D2), the incineration of sewage sludge from stage (1A2) to form sewage sludge ash takes place in a waste incineration plant at 600° to 1,200° C., preferably at 800° to 900° C.

In preferred embodiments of stage (1D3) or (2D3), the sewage sludge ash from stage (1D2) or (2D2) is treated with phosphoric acid. Preferably, this treatment is carried out for a period of less than 5 minutes, or less than 2 minutes, or between 5 minutes and 45 minutes, or from 2 to 300 minutes, preferably from 10 to 60 minutes, or from 2 to 20 minutes and preferably this treatment is carried out at a temperature above 40° C. or above 50° C. or from 20° C. to 90° C., preferably from 60 to 80° C. or from 20 to 80° C. or from 25 to 50° C. Preferably, the acid is at a concentration of 5% by weight to 50% by weight, preferably 10% by weight to 30% by weight (in aqueous dilution) and/or the sewage sludge ash is treated in a reactor with the acid and/or the proportion of sewage sludge ash is 5% by weight to 50% by weight, preferably 20% by weight to 30% by weight or 25% by weight to 35% by weight based on the acid. The treatment of the sewage sludge ash from stage (1D2) or (2D2) with phosphoric acid is particularly preferably carried out for a period of less than 2 minutes or from 2 to 20 minutes at a temperature of from 20 to 80° C. or from 25 to 50° C., the acid is present in a concentration of 10% by weight to 30% by weight (in aqueous dilution) and the proportion of sewage sludge ash is 20% by weight to 30% by weight or 25% by weight to 35% by weight based on the acid. The treatment of the sewage sludge ash from stage (1D2) or (2D2) with phosphoric acid is especially preferably carried out for a period of 2 to 20 minutes at a temperature of 25 to 50° C., the acid is present at a concentration of 10% by weight to 30% by weight (in aqueous dilution) and the proportion of sewage sludge ash is 25% by weight to 35% by weight, based on the acid.

In preferred embodiments of stage (2D4), the acid-insoluble portion of the treated sewage sludge ash from stage (1D3) or (2D3) is separated, resulting in an acid-insoluble portion and a filtrate or supernatant in the form of a phosphoric acid-containing liquid. In preferred embodiments of the invention, the acid-insoluble portion of the treated sewage sludge ash from stage (1D3) or (2D3) is separated with mechanical filtration and/or dewatering processes. In preferred embodiments of the invention, the acid-insoluble part of the treated sewage sludge ash from stage (1D3) or (2D3) is separated with dewatering units (e.g. vacuum belt filter, chamber filter press, membrane filter press, belt filter press, centrifuge). In preferred embodiments of the invention, the acid-insoluble part of the treated sewage sludge ash from stage (1D3) or (2D3) is separated with a vacuum belt filter. In preferred embodiments of the invention, after separation of the acid-insoluble part of the treated sewage sludge ash from stage (1D3) or (2D3), the residue is washed with water in the filter units and the washing water is returned to stage (1D3) or (2D3).

In preferred embodiments of stage (1D5) or (2D5), at least a part of the phosphoric acid-containing liquid from stage (1D4) or (2D4) is recycled for use in stage (1D3) or (2D3). Preferably at least 10% of the phosphoric acid-containing liquid from stage (1D4) or (2D4) is recycled for use in stage (1D3) or (2D3), more preferably at least 20%, even more preferably from 20% to 80%, and most preferably 40% to 60%, based on the total amount obtained of the phosphoric acid-containing liquid from stage (1D4) or (2D4). In preferred embodiments of stage (1D5) or (2D5), this stage is carried out after stage (1D6) or after stage (2D6) and before stage (1D7) or (2D7).

In preferred embodiments of stage (1D6) or (2D6), the phosphoric acid-containing liquid from stage (1D4) or (2D4) is purified by adding sulfuric acid to the phosphoric acid-containing liquid from stage (1D4) or (2D4), so that a Calcium sulfate precipitate is recovered and separated. This can be followed—but only in a preferred embodiment—by the use of ion exchange or liquid-liquid extraction, with ion exchange (in particular using ion exchange resins and regeneration with mineral acids) being preferred. In any case, a purified phosphoric acid-containing liquid is formed.

With regard to purification by adding sulfuric acid to the phosphoric acid-containing liquid from stage (1D4) or (2D4), the sulfuric acid is preferably added in a stirred reactor. It is also preferred that the sulfuric acid is added in a dilution of 10 to 98% by weight, preferably 40 to 80% by weight, preferably in a stirred reactor, with the sulfuric acid preferably being added in a molar ratio so that it is equivalent to the dissolved calcium concentration of 0.5 Ca to 1.5 SO₄, preferably 1.0 Ca to 1.0 SO₄. The residence time in the stirred reactor after addition of the sulfuric acid is 5 to 60 minutes, preferably 10 to 30 minutes, and/or the reaction temperature (precipitation of calcium sulfate after addition of sulfuric acid) in the stirred reactor is 20° to 90° C., preferably 60° to 90° C. It is further preferred that the calcium sulphate precipitate is recovered and separated using a mechanical filtration and/or dewatering process. The calcium sulphate precipitate is preferably separated using dewatering units (e.g. vacuum belt filter, chamber filter press, membrane filter press, belt filter press, centrifuge). The calcium sulphate precipitate is particularly preferably separated using a vacuum belt filter. Preferably, after the calcium sulphate precipitate has been separated, the residue in the filter units is washed with water and the washing water is recycled for use in stage (1D3) or (2D3).

In preferred embodiments of stage (1D7) or (2D7), at least a part of the purified phosphoric acid-containing liquid from stage (1D6) or (2D6) is concentrated so that phosphoric acid is recovered and separated, this preferably being done by evaporation.

In preferred embodiments of stage (2E), the ammonia [NH₃] obtained in stage (2B2) and/or the ammonia [NH₃] obtained in stage (2C4) are reacted with phosphoric acid [H₃PO₄] in the form of the phosphoric acid-containing liquid from stage (2D4), the purified phosphoric acid-containing liquid from stage (2D6) and/or the phosphoric acid from stage (2D7) to give ammonium phosphate compound. Preferably, the ammonium phosphate compound is di-ammonium hydrogen phosphate [(NH₄)₂HPO₄] (fertilizer). The resulting diammonium phosphate can be used locally as an aqueous, approx. 10% solution directly as a fertilizer or crystallized out by evaporation and cooling and dried and granulated to form a common NP fertilizer, with the optional separation of the ammonium phosphate compound obtained. The phosphoric acid is preferably added in the form of the phosphoric acid-containing liquid from stage (1D4) or the purified phosphoric acid-containing liquid from stage (1D6). The phosphoric acid is preferably added in the form of the phosphoric acid-containing liquid from stage (1D4). The phosphoric acid is preferably added in the form of the purified phosphoric acid-containing liquid from stage (1D6), in particular after the precipitation of calcium sulphate precipitate CaSO₄. Preferably, the phosphoric acid is used at a concentration of 10-15%. The phosphoric acid [H₃PO₄] can also be used in a concentration of 40-89% by weight or in a concentration of 50-75% by weight. The ammonia is preferably used in the form of ammonia water. Preferably, the ammonia is used at a concentration of about 25%. The ammonia is preferably used in the form of ammonia water with a concentration of about 25%. The ammonia is preferably reacted with the phosphoric acid in a trickle system (phosphoric acid trickling system). In a preferred embodiment, in stage (2E) the ammonia obtained in stage (2B2) and in stage (2C4) is reacted with phosphoric acid. The phosphoric acid is preferably used in the form of the purified phosphoric acid-containing liquid from stage (2D6) and/or the phosphoric acid from stage (2D7).

In preferred embodiments of stage (1 E), the ammonia [NH₃] obtained in stage (1B2) is reacted with phosphoric acid [H₃PO₄] in the form of the phosphoric acid-containing liquid from stage (1D4), the purified phosphoric acid-containing liquid from stage (1D6) and/or the phosphoric acid from stage (1D7) to give ammonium phosphate compound. Preferably, the ammonium phosphate compound is di-ammonium hydrogen phosphate [(NH₄)₂HPO₄] (fertilizer). The resulting diammonium phosphate can be used locally as an aqueous, approx. 10% solution directly as a fertilizer or crystallized out by evaporation and cooling and dried and granulated to form a common NP fertilizer, with the optional separation of the ammonium phosphate compound obtained. The phosphoric acid is preferably added in the form of the phosphoric acid-containing liquid from stage (1D4) or the purified phosphoric acid-containing liquid from stage (1D6). The phosphoric acid is preferably added in the form of the phosphoric acid-containing liquid from stage (1D4). The phosphoric acid is preferably added in the form of the purified phosphoric acid-containing liquid from stage (1D6), in particular after the precipitation of calcium sulphate precipitate CaSO₄. Preferably, the phosphoric acid is used at a concentration of 10-15%. The phosphoric acid [H₃PO₄] can also be used in a concentration of 40-89% by weight or in a concentration of 50-75% by weight. The ammonia is preferably used in the form of ammonia water. Preferably, the ammonia is used at a concentration of about 25%. The ammonia is preferably used in the form of ammonia water with a concentration of about 25%. The ammonia is preferably reacted with the phosphoric acid in a trickle system (phosphoric acid trickling system). In a preferred embodiment, the ammonia obtained in stage (1B2) is reacted with phosphoric acid in stage (1 E). The phosphoric acid is preferably used in the form of the purified phosphoric acid-containing liquid from stage (1D6) and/or the phosphoric acid from stage (1D7).

### Definitions

In the sense of the invention, the term “calcium phosphate” encompasses Ca₃(PO₄)₂), CaHPO4, Ca₅(PO₄)₃(OH) and Ca(H₂PO₄)₂.

In the sense of the invention, the term “ash” refers to any solid residue from the incineration of organic material. In the sense of this invention, it is especially the solid residue from the incineration of sewage sludge. In principle, it can also be the solid residue from the incineration of biodegradable wastes, bio-wastes and/or animal wastes, slaughterhouse wastes, e.g. animal meal. Ash consists mainly of oxides, and (bi)carbonates of various metals, e.g. Al2O3, CaO, Fe2O3, MgO, MnO, P2O5, P₄O₁₀, K2O, SiO2, Na2CO3, NaHCO3, etc.

In the sense of the invention, the term “phosphate-containing ash” refers to ashes, as defined herein, which contain at least one phosphate, as defined herein.

In the sense of the invention, on the one hand, the term “phosphates” concerns P₂O₅ and P₄O₁₀. Furthermore, the term “phosphates” refers to the salts and esters of orthophosphoric acid (H₃PO₄), and involves expressly the condensates (polymers) of orthophosphoric acid and their esters. In particular, the term “phosphates” refers to metallic salts of phosphoric acid with the general formula X(Y)m(PO₄)n, where X and optionally Y is a metal selected from the group consisting of aluminium, beryllium, bismuth, lead, cadmium, chromium, iron, gallium, indium, potassium, cobalt, copper, magnesium, manganese, molybdenum, sodium, nickel, osmium, palladium, rhodium, ruthenium, strontium, titanium, vanadium, tungsten, zinc, tin.

In the context of the invention, the term “precipitate” refers to the elimination of a dissolved substance as solid from a solution, usually initiated by additives of suitable substances (precipitant). In particular, the term encompasses any fully or partially insoluble precipitate in form of flakes, droplets or crystalline material, in any microcrystalline, crystalline or amorphous form. According to the invention, the term “precipitate” expressly involves any further processing, modification, refining, etc., of comprised precipitates into powders, fine powders, dusts, bulk material, granular materials, semolina etc.

In the sense of the invention, the term “waste-incineration plants” refers to all installations, facilities and the like, which are suitable for incineration of the atmosphere combustible components of any type of waste.

In the sense of the invention, the term “sewage sludge” refers to any suspension of finely dispersed particles of a solid substance in a liquid. The sewage sludge can be in the form of primary sludge, raw sludge, excess sludge, treated and/or stabilized sewage sludge (aerobic/anaerobic). In particular/preferably it is (mechanically) dewatered sewage sludge and/or in particular/preferably sewage sludge with 15% to 30% dry matter, in particular approx. 25% (DM, dry matter).

In a preferred embodiment, the liquid, in which the particles are suspended, is waste water as herein defined.

In the sense of the invention, the term “waste water” relates to all liquids of aqueous nature and/or organic nature, or mixtures thereof, which do not have drinking water quality within the meaning of the Drinking Water Ordinance (TrinkwV) and/or of national and/or international drinking water standards (e.g. DIN 2000 in Germany). The term waste water comprises further all waste water in accordance with § 54 para. 1 of the Water Resources Act (WHG).

In a preferred embodiment, according to the waste water in the sense of the invention, water can be contaminated or in its properties or its composition modified due to its use. Furthermore, in the sense of the invention, the term “waste water” comprises water, which properties are modified because of domestic, commercial, agricultural or other use and that during dry-weather with it together flowing off water (dirty water) as well as the flowing off water from rainfall, which can be collected from the region of built-up or fortified areas (rain water). The leakage and collected liquids from facilities for treatment, storage and deposition of waste are also considered as waste water. Waste water is domestic waste water from toilets (faecal or black water), sanitary facilities, kitchens and washing machines (washing or grey water) as well as waste water from premises, which discharge into the public sewage system (commercial or industrial waste water). Heated water from cooling systems counts also as waste water. According to the invention, waste water resulting from a variety of cleaning and treatment techniques from water treatment plants accounts to the waste water.

1. Process (1) for the combined recovery of phosphate and nitrogen from sewage sludge, comprising the following process stages:
Stage (1A1): Optional disintegration of the sewage sludge;
Stage (1A2): Drying of the sewage sludge, resulting in vapors rich in NH₃ and dried sewage sludge;
Stage (1B1): Optional condensing of the NH₃-rich vapors from Stage (1A2);
Stage (1B2): Optional alkalizing of the condensed NH₃-rich vapors from stage (1B1) with release of ammonia [NH₃], and driving out of the ammonia [NH₃] with heating and/or by applying a reduced pressure and/or with the aid of an air or steam flow (ammonia stripping 1);
Stage (1D2): Incinerating the dried sewage sludge from stage (1A2) into sewage sludge ash;
Stage (1D3): Treating the sewage sludge ash from stage (1D2) with phosphoric acid;
Stage (1D4): Separating the acid-insoluble portion of the treated sewage sludge ash from stage (1D3) to produce an acid-insoluble portion and a filtrate or supernatant in the form of a phosphoric acid-containing liquid;
Stage (1D5): Optional recycling of at least a part of the phosphoric acid-containing liquid from stage (1D4) for use in stage (1D3);
Stage (1D6): Purifying the phosphoric acid-containing liquid from stage (1D4) by adding sulfuric acid to the phosphoric acid-containing liquid from stage (1D4) so that a calcium sulfate precipitate is recovered and separated, and/or by applying ion exchange or Liquid-liquid extraction, resulting in a purified phosphoric acid-containing liquid;
Stage (1D7): Optional concentrating of at least a part of the purified phosphoric acid-containing liquid from stage (1D6) so that phosphoric acid is recovered and separated; and
Stage (1 E): Reacting the condensed NH₃-rich vapors from stage (1B1) and/or the ammonia [NH₃] obtained in stage (1B2) with phosphoric acid [H₃PO₄] in the form of the phosphoric acid-containing liquid from stage (1D4), the purified phosphoric acid-containing liquid from stage (1D6) and/or the phosphoric acid from stage (1D7) to obtain ammonium phosphate compound and optional separating off of the ammonium phosphate compound obtained.

2. Combination process (2) for the combined recovery of phosphate and nitrogen from sewage sludge and biological waste, the biological waste comprising an aqueous liquid phase in which at least urea and ammonium compounds and inorganically and organically bound phosphates are dissolved and/or contained in particulate form, comprising the following process stages:
Stage (2A1): Optional disintegration of the sewage sludge;
Stage (2A2): Drying of the sewage sludge, resulting in vapors rich in NH₃ and dried sewage sludge;
Stage (2B1): Optional condensing of the NH₃-rich vapors from Stage (2A2);
Stage (2B2): Optional alkalizing of the condensed NH₃-rich vapors from stage (2B1) with release of ammonia [NH₃], and driving out the ammonia [NH₃] with heating and/or by applying a reduced pressure and/or with the aid of an air or steam flow (ammonia stripping 2);
Stage (2C1): Optionally separating the solids of the biological waste from the liquid phase;
Stage (2C2): Introducing carbon dioxide gas [CO₂] under increased pressure or supercritical carbon dioxide into the liquid phase of the biological waste in order to solubilize particulate-bound phosphates;
Stage (2C3): Reducing the CO₂ content in the liquid phase from stage (2C2) by acidifying the liquid phase and driving off dissolved CO₂ and/or CO₂ bound as carbonate;
Stage (2C4): Alkalizing the liquid phase from stage (2C3) with release of ammonia [NH₃] and driving out the ammonia [NH₃] with heating and/or by applying a reduced pressure and/or with the aid of an air or steam stream (ammonia stripping 3);
Stage (2C5): Precipitation and separation of calcium phosphate from the liquid phase from stage (2C4);
Stage (2D1): Admixing the precipitated and separated calcium phosphate from stage (2C5) to the dried sewage sludge from stage (2A);
Stage (2D2): Incinerating the mixture of precipitated and separated calcium phosphate from stage (2C4) and dried sewage sludge from stage (2A) to sewage sludge ash;
Stage (2D3): Treating the sewage sludge ash from stage (2D2) with phosphoric acid;
Stage (2D4): Separating the acid-insoluble portion of the treated sewage sludge ash from stage (2D3) to produce an acid-insoluble portion and a filtrate or supernatant in the form of a phosphoric acid-containing liquid;
Stage (2D5): Optional recycling of at least a part of the phosphoric acid-containing liquid from stage (2D4) for use in stage (2D3);
Stage (2D6): Purifying the phosphoric acid-containing liquid from stage (2D4) by adding sulfuric acid to the phosphoric acid-containing liquid from stage (2D4) so that a calcium sulfate precipitate is recovered and separated, and/or by applying ion exchange or Liquid-liquid extraction, resulting in a purified phosphoric acid-containing liquid;
Stage (2D7): Optional concentrating of at least a part of the purified phosphoric acid-containing liquid from stage (2D6) so that phosphoric acid is recovered and separated;
Stage (2E): Reacting the condensed NH₃-rich vapors from stage (2B1) and/or the ammonia [NH₃] obtained in stage (2B2) and the ammonia [NH₃] obtained in stage (2C4) with phosphoric acid [H₃PO₄] in the form of the phosphoric acid-containing liquid from stage (2D4), the purified phosphoric acid-containing liquid from stage (2D6) and/or the phosphoric acid from stage (2D7) to obtain ammonium phosphate compound, and optionally separating the ammonium phosphate compound obtained.

3. Process (1) according to claim 1 or combination process (2) according to claim 2, wherein stage (1D5) or (2D5), recycling the phosphoric acid-containing liquid from stage (1D4) or (2D4) for use in stage (1D3) or (2D3), is carried out, with preferably at least 10% of the phosphoric acid-containing liquid from stage (1D4) or (2D4) being recycled for use in stage (1D3) or (2D3), more preferably at least 20%, still more preferably 20% to 80%, and most preferably 40% to 60%, based on the total amount of phosphoric acid-containing liquid obtained from stage (1D4) or (2D4).

4. Process (1) according to claim 1 or 3 or combination process (2) according to claim 2 or 3, wherein stage (1A1) or (2A1), the disintegration of the sewage sludge, is carried out before stage (1A2) or (2A2), preferably by mechanical treatment, for example using a ball mill, by treatment using ultrasound and/or at elevated pressure and temperature.

5. Process (1) according to any one of claim 1, 3 or 4 or combination process (2) according to any one of claims 2 to 4, wherein stage (1B2) or (2B2), the alkalizing of the condensed NH₃-rich vapors from stage (1B1) or (2B1), is carried out, preferably by means of addition of NaOH, optionally with further addition of CaO or Ca(OH)₂ (milk of lime), and/or with the aid of an air or steam stream.

6. Process (1) according to any one of claims 1 and 3 to 5 or combination process (2) according to any one of claims 2 to 5, wherein stage (1D7) or (2D7), concentrating at least a part of the purified phosphoric acid-containing liquid from stage (2D6) so that phosphoric acid is recovered and separated, is carried out, preferably by evaporation.

7. Process (1) according to any one of claims 1 and 3 to 6 or combination process (2) according to any one of claims 2 to 6, wherein stage (1D6) or (2D6), the purification of the phosphoric acid-containing liquid from stage (1D4) or (2D4) is carried out by adding sulfuric acid so that a calcium sulfate precipitate is recovered and separated and a purified phosphoric acid-containing liquid is obtained.

8. Process (1) or combination process (2) according to claim 7, wherein in stage (1D6) or (2D6), the purification of the phosphoric acid-containing liquid from stage (1D4) or (2D4) by adding sulfuric acid, is followed by a further purification by applying ion exchange or liquid-liquid extraction, particularly preferably by ion exchange.

9. Process (1) according to any one of claims 1 and 3 to 8 or combination process (2) according to any one of claims 2 to 8, wherein in stage (1 E) the ammonia obtained in stage (1B2) is reacted with phosphoric acid or in stage (2E) the ammonia obtained in stage (2B2) and the ammonia obtained in stage (2C4) is reacted with phosphoric acid, the phosphoric acid used preferably being in the form of the purified phosphoric acid-containing liquid from stage (1D6) or (2D6) and/or the phosphoric acid from stage (1D7) or (2D7).

10. Combination process (2) according to any one of claims 2 to 9, wherein stage (2C1), the separation of the solids of the biological waste from the liquid phase, is carried out before stage (2C2), preferably by centrifugation.
